(19) United States
(12) Patent Application Publication
(10) Pub. No.: US 2021/0297680 A1
(43) Pub. Date: Sep. 23, 2021

(54) RESIDUAL REFINEMENT OF COLOR COMPONENTS

(71) Applicant: Telefonaktiebolaget LM Ericsson (publ), Stockholm (SE)

(72) Inventors: Ying WANG, Stockholm (SE); Kenneth ANDERSSON, Gävle (SE); Jacob STRÖM, Stockholm (SE); Per WENNERSTEN, Årsta (SE)

(73) Assignee: Telefonaktiebolaget LM Ericsson (publ), Stockholm (SE)

(21) Appl. No.: 16/341,305

(22) PCT Filed: Oct. 6, 2017
(86) PCT No.: PCT/SE2017/050976

§ 371 Date: Apr. 11, 2019

Related U.S. Application Data
(60) Provisional application No. 62/407,114, filed on Oct. 12, 2016.

(51) Int. Cl. H04N 19/186; H04N 19/117; H04N 19/176; H04N 19/85; H04N 19/80; H04N 19/50

(52) U.S. Cl. CPC H04N 19/186; H04N 19/117; H04N 19/50; H04N 19/85; H04N 19/80; H04N 19/176

(57) ABSTRACT

A refined reconstruction block of a first color component in a picture is determined by at least one of clipping and bilateral filtering a sum of a prediction block of the first color component and a residual of the first color component. A residual block of a second color component is predicted from the refined 5 construction block of the first color component. Applying clipping and/or filtering to the first color component prior to using it in cross-component prediction of the second color component improves and refines predictions or residuals of another color component.

### TECHNICAL FIELD

The present embodiments generally relate to image and video coding, and in particular to residual refinement in such image and video coding.

### BACKGROUND

In state of the art image and video coding, samples of a source block in a picture is first predicted by use of samples that previously have been coded and, thus, are available for prediction in a decoder, typically denoted prediction block. On the encoder side the difference between source samples, i.e., source block, and the predicted samples, i.e., prediction block, is a residual block, which is coded by the use of a spatial transform and quantization of transform coefficients or with quantization of the difference (transform skip). A reconstruction is then made by performing inverse quantization of quantized transform coefficients and inverse transformation to obtain a residual block, which then is added to a prediction block to form a reconstruction block as reconstructed representation of the source block. To make sure that the reconstruction is within the allowed range of sample values, a clipping is made before storing the reconstruction. If the video has 8 bit bit-depth the sum of prediction and residual is clipped to be within 0 and 255 and if it has 10-bit bit-depth the sum of prediction and residual is clipped to be within 0 and 1023 in High Efficiency Video Coding (HEVC), also known as H.265 and MPEG-H Part 2.

After this, in-loop filtering is performed on reconstructed samples. Typically, first de-blocking filtering followed by other in-loop filters, such as SAO (sample adaptive offset) and possibly also ALF (adaptive loop filtering).

HEVC has a Cross-Component Prediction (CCP) tool [1] for predicting the residuals of the chrominance blocks of samples, also denoted pixels in the art, from the residuals of the luminance blocks of samples or pixels. The tool was initially proposed during the development of H.265/HEVC RExt that supports higher bit depths and 4:2:2 and 4:4:4 chroma sampling formats for the HEVC.

The residual of a chroma component r_{CR} is calculated as:

r_{CR}=\hat{r}_{CR}−α\hat{r}_{CM}

wherein \hat{r}_{CM} is the luma component residual, \hat{r}_{CR} is the residual of the remaining component at the same spatial location and α is a weighting factor. The α parameter is signaled at the block level in the bit stream for each of the two chroma components.

One of the tools in JEM (JVET-C1001_V3) is cross-component linear model (CCLM) prediction [2], where the residual of one of the chroma components may also be predicted from the residual of the other chroma component according to:

pred_{Cr*}(i,j)=pred_{Cr}(i,j)+α×resi_{Cb′}(i,j)

Although, CCP and CCLM can be used to improve the predictions of chroma components, there is still room for further advantages in determining predictions and residuals for color components.

### SUMMARY

It is a general objective to refine residuals during encoding and/or decoding.

It is a particular objective to refine residuals in connection with prediction across color components during encoding and/or decoding.

This and other objectives are met by embodiments as disclosed herein.

An aspect of the embodiments relates to a method for residual prediction for a picture. The method comprises determining a refined reconstruction block of a first color component in the picture by at least one of clipping and bilateral filtering a sum of a prediction block of the first color component and a residual of the first color component. The method also comprises predicting a residual block of a second color component from the refined construction block of the first color component.

Another aspect of the embodiments relates to a device for residual prediction for a picture. The device is configured to determine a refined reconstruction block of a first color component in the picture by at least one of clipping and bilateral filtering a sum of a prediction block of the first color component and a residual block of the first color component. The device is also configured to predict a residual block of a second color component from the refined reconstruction block of the first color component.

A further aspect of the embodiments relates to a device for residual prediction for a picture. The device comprises a refining module for determining a refined reconstruction block of a first color component in the picture by at least one of clipping and bilateral filtering a sum of a prediction block of the first color component and a residual block of the first color component. The device also comprises a predicting module for predicting a residual block of a second color component from the refined reconstruction block of the first color component.

Further aspects include an encoder and a decoder comprising a device for residual prediction for a picture according to the embodiments and a user equipment comprising an encoder and/or decoder according to the embodiments. The user equipment is selected from the group consisting of a mobile telephone, a smart phone, a tablet, a desktop a netbook, a multimedia player, a video streaming server, a set-top box, a game console and a computer.

Yet another aspect of the embodiments relates to a computer program comprising instructions, which when executed by at least one processor, cause the at least one processor to determine a refined reconstruction block of a first color component in a picture by at least one of clipping and bilateral filtering a sum of a prediction block of the first color component and a residual block of the first color component. The at least one processor is also caused to predict a residual block of a second color component from the refined reconstruction block of the first color component.

A related aspect defines a carrier comprising the computer program. The carrier is one of an electronic signal, an optical signal, an electromagnetic signal, a magnetic signal, an electric signal, a radio signal, a microwave signal, or a computer-readable storage medium.

The present embodiments enable improvement in coding by clipping and/or applying filtering on reconstructed samples of one color component that are to be used in cross-component prediction of samples of another color component.

### BRIEF DESCRIPTION OF THE DRAWINGS

The embodiments, together with further objects and advantages thereof, may best be understood by making reference to the following description taken together with the accompanying drawings, in which:

FIG. 1 is a flow chart illustrating a method for residual prediction according to an embodiment;

FIG. 2 is a flow chart illustrating determining a refined reconstruction block in FIG. 1 according to an embodiment;

FIG. 3 is a flow chart illustrating determining a refined reconstruction block in FIG. 1 according to another embodiment;

FIG. 4 is a flow chart illustrating determining a refined reconstruction block in FIG. 1 according to a further embodiment;

FIG. 5 is a flow chart illustrating determining a refined reconstruction block in FIG. 1 according to yet another embodiment;

FIG. 6 is a flow chart illustrating an additional, optional step of the method shown in FIG. 1;

FIG. 7 is a flow chart illustrating determining a refined reconstruction block in FIG. 1 according to another embodiment;

FIG. 8 is a flow chart illustrating determining a refined reconstruction block in FIG. 1 according to a further embodiment;

FIG. 9 is a schematic block diagram of a video encoder according to an embodiment;

FIG. 10 is a schematic block diagram of a video decoder according to an embodiment;

FIG. 11 is a schematic block diagram of a device for residual prediction according to an embodiment;

FIG. 12 is a schematic block diagram of a device for residual prediction according to another embodiment;

FIG. 13 is a schematic block diagram of a device for residual prediction according to a further embodiment;

FIG. 14 schematically illustrate a computer program based implementation of an embodiment;

FIG. 15 is a schematic block diagram of a device for residual prediction according to yet another embodiment;

FIG. 16 is a schematic block diagram of an encoder according to an embodiment;

FIG. 17 is a schematic block diagram of an encoder according to another embodiment;

FIG. 18 is a schematic block diagram of a decoder according to an embodiment;

FIG. 19 is a schematic block diagram of a decoder according to another embodiment;

FIG. 20 is a schematic block diagram of a user equipment according to an embodiment;

FIG. 21 schematically illustrates a distributed implementation among network devices; and

FIG. 22 is a schematic illustration of an example of a wireless communication system with one or more cloud-based network devices according to an embodiment.

### DETAILED DESCRIPTION

The present embodiments generally relate to image and video coding, and in particular to residual refinement in such image and video coding.

The prior art refinement of a chroma component achieved in CCP and CCLM using the residual of the luma component or the other chroma component have shortcomings.

In particular, one problem with CCP is that when the residual for the luma component is used for prediction of the residual component it does not take advantage of the clipping operation that is otherwise applied when forming the reconstruction of the luma component. Accordingly, the non-clipped residual for the luma component can be suboptimal for CCP.

Correspondingly, one problem with CCLM is that when the residual of first chroma component is used for prediction of a residual of a second chroma component it does not take advantage of the clipping operation that is otherwise when forming the reconstruction of the first chroma component. Accordingly, the non-clipped residual for the first chroma component can be suboptimal for CCLM.

According to the embodiments a refinement of a residual of a first color component by at least one of clipping and bilateral filtering is first done prior to predicting the residual of a second color component from the refined residual of the first color component. Accordingly, a better and more accurate residual of the second color component can be obtained as compared to the prior art using non-clipped and non-filtered residuals in, for instance, CCP and CCLM.

Image and video coding involves coding and decoding of pixels, also referred to as samples, in the image or pictures. Each such pixel, or sample, has a number of, typically three, pixel or sample values, denoted color component values herein. Thus, a pixel or sample in a picture typically has three color components, the values of which together represent the color of the particular pixel or sample in a color space.

Image and video coding uses various color spaces and formats to represent the colors of the pixels or samples. Non-limiting, but illustrative, examples of such color spaces or formats include red (R), green (G), blue (B) color, i.e., RGB color; luma (Y′) and chroma (Cb, Cr) color, i.e., Y′CbCr color; luminance (Y) and chrominance (X, Z) color, i.e., XYZ color; intensity (I) and chroma (Ct, Cp) color, i.e., ICtCp color; luma (Y′) and chrominance (U, V), i.e., Y′UV color. In such a case, a color component as used herein could be any color component, such as a R, G, B, Y′, Cb, Cr, X, Y, Z, I, Ct, Cp, U or V. In a particular embodiment, a color component is a luma component Y′ or a chroma component Cb or Cr.

Hence, in an embodiment the picture comprises multiple pixels having a respective luma component and two chroma components. A second color component as used herein is, in this embodiment, one of the two chroma components. A first color component as used herein is, in this embodiment, the luma component or the other of the two chroma components.

Image and video coding typically involves partitioning pictures into blocks of pixels or samples, i.e., block-based or block-oriented coding. Various denotations of such blocks of pixel or samples are generally used, such as source block, prediction block, residual block, transform block and reconstruction block. A source block as used herein represents a portion of a picture to be encoded. A prediction block is a prediction obtained for the source block and is used, during encoding, to derive a residual block as a difference between the source block and the prediction block. The residual block is then transformed and quantized or quantized to get an encoded representation of the source block. The transform is applied to a transform block, which could be of the same size as the residual block or constitute a portion of the residual block. A reconstruction block, i.e., a reconstruction of the original source block, is in turn obtained following inverse quantization and possibly inverse transform to obtain a residual block that is added to a prediction block.

The source block, prediction block, residual block, transform block and reconstruction block have a respective size in terms of number of pixels or samples, typically M×N pixels, in which M may be the same or different from N. The actual values of M, N depend on the particular image or video coding standard.

The present embodiments are particularly applicable to video coding in which a video sequence of multiple pictures is encoded into a bit stream. During decoding, the bit stream is decoded in order to obtain a reconstruction of the pictures and the video sequence. The present embodiments can be applied to any video coding standard that determines reconstructions (reconstruction blocks), predictions (prediction blocks) and residuals (residual blocks) and in which pixels or samples have at least two, preferably three color components. Non-limiting, but illustrative examples, of such video coding standards include HEVC; its predecessors, such as H.264 or MPEG-4 Part 10, Advanced Video Coding (MPEG-4 AVC); and its successors, such as H.266.

The present embodiments are in particular applicable to video coding that uses various forms of cross-component predictions over color components, such as CCP and/or CCLM.

FIG. 1 is a flow chart illustrating a method for residual prediction for a picture according to an embodiment. The method comprises determining, in step S1, a refined reconstruction block of a first color component in the picture by at least one of clipping and bilateral filtering a sum of a prediction block of the first color component and a residual of the first color component. A next step S2 then comprises predicting a residual block of a second color component from the refined construction block of the first color component.

Thus, according to the embodiments a refined reconstruction block of the first color component in the pictures is first determined by means of at least one of clipping and bilateral filtering of the sum of the prediction block and the residual block of the first color component, i.e., the reconstruction block of the first color component. Thus, in clear contrast to prior art CCP and CCLM, in which the residual block of the first color component is used directly without any clipping or bilateral filtering, the present embodiments first determines a refined reconstruction block of the first color component. This refined reconstruction block of the first color component is then used when predicting the residual block of the second color component. The present embodiments thereby take advantage of clipping and/or bilateral filtering and thereby enable a more accurate prediction across color components.

As mentioned in the foregoing, a reconstruction block is a sum of a prediction block and a residual block. Accordingly, determining a refined reconstruction block of the first color component in step S1 by at least one of clipping and bilateral filtering the sum of the prediction block of the first color component and the residual block of the second color component is equivalent to determining a refined reconstruction block of the first color component by at least one of clipping and bilateral filtering a reconstruction block of the first color component. Accordingly, step S1 could be performed in a single step, rec′₁=f(pred₁+res₁), or in two sub-steps, rec₁=pred₁+res₁ and rec′₁=f(rec₁), wherein red denotes the reconstruction block of the first color component, rec′₁ denotes the refined reconstruction block of the first color component, pred₁ denotes the prediction block of the first color component, res₁ denotes the residual block of the first color component and f(.) denotes the clipping and/or bilateral filtering operation(s).

As mentioned in the foregoing, prediction, residual and reconstruction blocks, have a certain size in terms of number of pixels and samples and further occupy a certain portion of a picture. In a particular embodiment, the residual block of a second color component preferably occupies or is associated with a same portion of a picture as the residual block of the first color component. This may imply that the residual blocks have a same size in terms of number of pixels or samples, in particular if the first and second color components are first and second chroma components. Generally, chroma samples are sub-sampled, whereas luma samples are not sub-sampled, resulting in, for instance, Y′CbCr 4:2:0 format or Y′CbCr 4:2:2 format, whereas the picture before sub-sampling and after sub-sampling and subsequent up-sampling is in Y′CbCr 4:4:4 format. Although a chroma residual block may, following sub-sampling, contain fewer pixels or samples, such as M/2×N/2, as compared to the associated luma residual block, M×N, the two residual blocks, however, occupy the same portion of the picture. This means that the residual block of the first color component and the residual block of the second color component preferably have the same size in terms of number of pixels or samples prior to any sub-sampling and following sub-sampling and subsequent up-sampling, and preferably occupy the same portion of a picture.

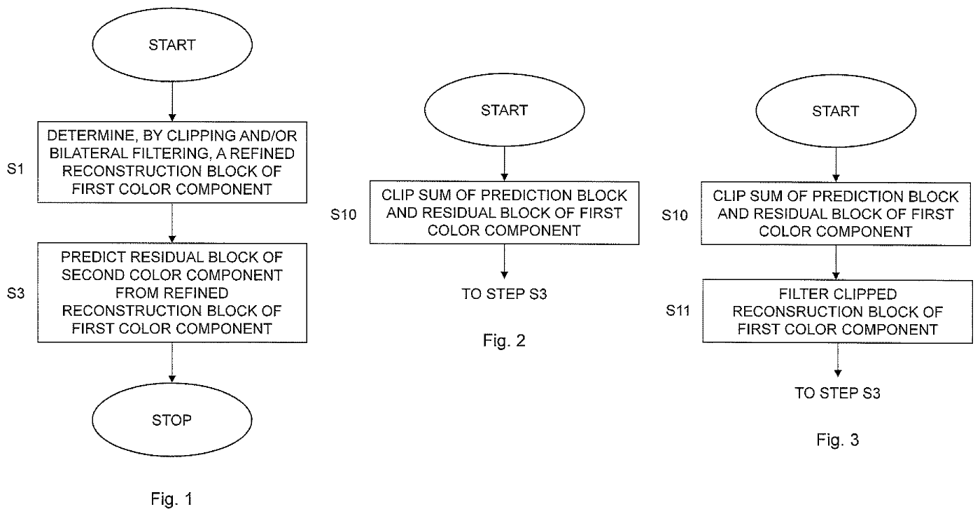

FIG. 2 is a flow chart illustrating an embodiment of step S1 in FIG. 1. In this embodiment, the refined reconstruction block of the first color component is determined by clipping, in step S10, the sum of the prediction block of the first color component and the residual block of the first color component to stay within an allowed range for the first color component. The method then continues to step S3 in FIG. 1.

Thus, in this embodiment the refined reconstruction block of the first color component is determined by clipping the sum of the prediction block and the residual block of the first color component, which is equivalent to clipping the reconstruction block of the first color component.

The clipping operation applied in step S10 forces the values of the pixels or samples in the reconstruction block of the first color component to stay within an allowed range for the first color component.

In an embodiment, the clipping operation applied in step S10 corresponds to Clip3(min, max, x), which outputs min if x<min, outputs max if x>max and otherwise outputs x. Min and max thereby constitute the clipping bounds defining the allowed range for the first color component.

In an embodiment, the clipping operation is according below:

recSamples[xCurr+i][yCurr+j]=clipCidx1(predSamples[i][j]+resamples[i][j]) with i=0 . . . nCurrSw−1, j=0 . . . nCurrSh−1, (xCurr, yCurr) specifies the top-left sample of the current block relative to the top-left sample of the current picture and the variables nCurrSw and nCurrSh specify the width and height, respectively, of the current block.

clipCidx1 corresponds to Clip1_{Y} if the first color component is a luma component and otherwise corresponds to Clip1_{C}, i.e., if the first color component is a chroma component.

Clip1_{Y}(x)=Clip3(0,(1<<BitDepth_{Y})−1,x)

Clip1_{C}(x)=Clip3(0,(1<<BitDepth_{C})−1,x)

BitDepth_{Y} and Bitdepth_{C} represent the bit depths of luma and chroma components, respectively.

In another embodiment, clipCidx1 corresponds to Clip1_{Y} if the first color component is a luma component, Clip1_{Cb} if the first color component is a chroma Cb component and Clip1_{Cr} if the first color component is a chroma Cr component.

Clip1_{Y}(x)=Clip3(min_{Y},max_{Y},x)

Clip1_{Cb}(x)=Clip3(min_{Cb},max_{Cb},x)

Clip1_{Cr}(x)=Clip3(min_{Cb},max_{Cb},x)

In this embodiment, the clipping bounds, i.e., min and max values, can be individually set for the luma and chroma components as compared to having a predefined same minimum value of zero and a maximum value determined based on the bit depth of the first color component. The clipping bounds min_{Y}, max_{Y}, min_{Cb}, max_{Cb}, min_{Cb}, max_{Cb} can be retrieved from the bit stream or predicted from previously determined clipping bounds [3, 4]. For instance, min_{Z}=clip_min_quant_adaptivez <<bit_depth_shift_clip and max_{Z}=clip_max_quant_adaptivez <<bit_depth_shift_clip, Z=Y, Cb, Cr and the parameters clip_min_quant_adaptive, clip_max_quant_adaptive and bit_depth_shift_clip may be signaled in the bit stream, such as in a slice header, a sequence parameter (SPS) and/or a picture parameter set (PPS).

The above presented examples should, however, merely be seen as illustrative examples of clipping operations that can be used in step S10 to clip the sum of the prediction block of the first color component and the residual block of the first color component to stay within the allowed ranges. Other clipping operations and other clipping bounds could instead be used.

In residual coding, transforms are used to reduce the redundancy in the frequency domain. One problem with transforms is that when they are used together with quantization they can produce ringing artifacts from the basis functions of the transforms. If this happens near the end points of the allowed range of sample values, clipping of the reconstruction can reduce the ringing.

FIG. 3 is a flow chart illustrating another embodiment of step S1 in FIG. 1. In this embodiment, the sum of the prediction block of the first color component and the residual block of the first color component is clipped in step S10 to stay within an allowed range for the first color component to form a clipped reconstruction block of the first color component. A next step S11 comprises filtering the clipped reconstruction block of the first color component with a filter to form the refined reconstruction block of the first color component. The method then continues to step S3 in FIG. 1.

This embodiment of step S1 thereby involves both performing a clipping operation in step S10 followed by performing a filtering operation in step S11. Step S10 in FIG. 3 is preferably performed as described above in connection with step S2 in FIG. 2 and is not further described herein.

The clipped reconstruction block of the first color component is in this embodiment subject to a filtering operation with a filter to form the refined reconstruction block of the first color component.

In an embodiment, the filter used in step S11 is a smoothing filter, such as a non-linear, edge-preserving and noise-reducing smoothing filter. A typical example of such a filter is a bilateral filter. A bilateral filter replaces the values of the first color components in the clipped reconstruction block with a weighted average of first color component values from nearby pixels or samples. In an embodiment, the weight can be based on a Gaussian distribution.

Unlike conventional linear filters having predetermined filter coefficients, a bilateral filter decides its filter coefficients based on the contrast of the pixels in addition to the geometric distance.

A Gaussian function has usually been used to relate coefficients to the geometric distance and contrast of the pixel values.

For a pixel located at (i, j) in the clipped reconstruction block of the first color component, which will be denoised using its neighboring pixel (k, l), the weight w(i, j, k, l) assigned for pixel (k, l) to denoise the pixel (i, j) is defined as according to equation (1) below:

$$ω ( i , j , k , l ) = e ( - \frac{{( i - k )}^{2} + {( j - l )}^{2}}{2 {σ}_{d}^{2}} - \frac{{‖ I ( i , j ) - I ( k , l ) ‖}^{2}}{2 {σ}_{r}^{2}} ) \qquad ( 1 )$$

σ_{d} is a spatial parameter, and a, is a range parameter. The bilateral filter is controlled by these two parameters. I(i, j) and I(k, l) are the values of the first color component of pixels (i, j) and (k,l) respectively.

After the weights are obtained, they are normalized, and the final filtered value I_{D}(i, j) of the first color component of pixel (i, j) is given by equation (2) below:

$${I}_{D} ( i , j ) = \frac{{\sum }_{k , l} I ( k , l ) * ω ( i , j , k , l )}{{\sum }_{k , l} ω ( i , j , k , l )} \qquad ( 2 )$$

A bilateral filter is an example of a preferred filter that can be used in step S11. The embodiments are, however, not limited thereto.

A preferred filter should smoothen coding noise, such as ringing, without removing true structure. Another non-linear filter that can be used in step S11, is a SAO, where an offset is added to edges that have specific characteristics, such as valleys or peaks, or when an offset is added to certain bands of sample values.

This embodiment thereby performs the clipping operation (clip( )) prior to the filtering operation (filter( )) to form the refined reconstructed block of the first color component, i.e., rec′₁=filter(clip(pred₁+res₁))=filter(clip(rec₁)) using the previously defined notation.

As mentioned in the foregoing, transforms, when used together with quantization, can produce ringing artifacts from the basis functions of the transforms. Using filtering and especially bilateral filtering can reduce the effect of ringing for sample values.

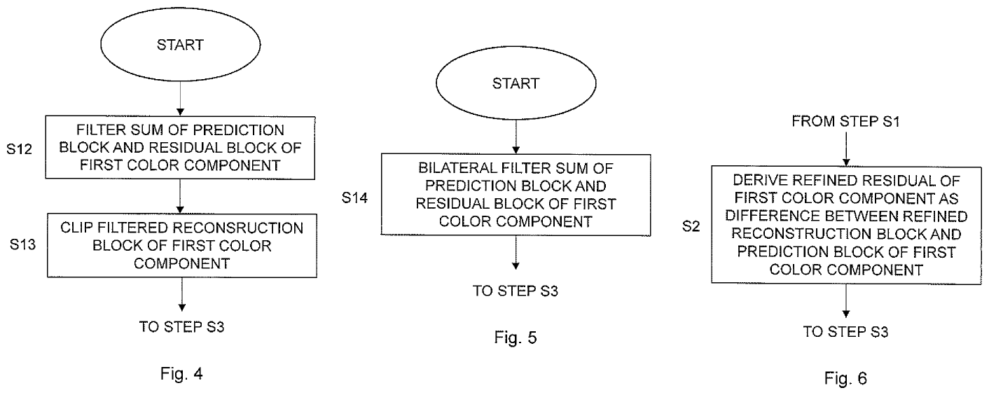

FIG. 4 is a flow chart illustrating a further embodiment of step S1 in FIG. 1. In this embodiment, the sum of the prediction block of the first color component and the residual block of the first color component is filtered in step S12 with a filter to form a filtered reconstruction block of the first color component. A next step S13 comprises clipping the filtered reconstruction block to stay within allowed range for the first color component to form the refined reconstruction block of the first color component. The method then continues to step S3 in FIG. 1.

This embodiment basically switches the order of the clipping operation and the filtering operation as compared to the embodiment shown in FIG. 3, i.e., rec′₁=clip(filter(pred₁+res₁))=clip(filter(rec₁)).

Step S12 in FIG. 4 is preferably performed as described above in connection with step S11 in FIG. 3 and is not further described herein. Correspondingly, step S13 in FIG. 4 is preferably performed as described above in connection with step S10 in FIGS. 2 and 3 and is not further described herein.

Performing filtering before clipping as in FIG. 4, could possible give a more natural/smooth behaving reconstruction, whereas doing the clipping before as in FIG. 3 may in some situations cause some abrupt changes in the reconstruction. However, an advantage of doing the clipping before filtering as in FIG. 3 can be that the dynamic range of the signal is less and, thus, the filtering could possibly be slightly less complex. If the filter can increase the max sample value or decrease the min sample value, a clipping as last stage could be preferred to avoid doing two clippings.

FIG. 5 is a flow chart illustrating yet another embodiment of step S1 in FIG. 1. This embodiment comprises filtering the sum of the prediction block of the first color component and the residual block of the first color component in step S12 with a bilateral filter to form the refined reconstruction block of the first color component. This is equivalent to filtering the reconstruction block of the first color component with a bilateral filter to form the refined reconstruction block of the first color component.

The bilateral filter is preferably as defined in equation (2) using weights as defined in equation (1).

FIG. 6 is a flow chart illustrating an additional, optional step of the method shown in FIG. 1. The method continues from step S1 in FIG. 1, or from any of steps S10, S11, S13 or S14 in FIGS. 2 to 5. A next step S2 comprises deriving a refined residual block of the first color component as a difference between the refined reconstruction block of the first color component and the prediction block of the first color component. The method then continues to step S3 in FIG. 1. In this embodiment, step S3 comprises predicting the residual block of the second color component from the refined residual block of the first color component.

Thus, the refined reconstruction block of the first color component determined in step S1, such as according to any of the embodiments shown in FIGS. 2 to 5, is in this embodiment used to derive a refined residual block of the first color component. This refined residual block of the first color component is then used to predict the residual block of the second color component.

Step S2 thereby calculates the refined residual block of the first color component (res′i) as a difference between the refined reconstruction block of the first color component and the prediction block of the first color component, i.e., res′₁=rec′₁−pred₁=f(pred₁+res₁)−pred₁=f(rec₁)−pred₁.

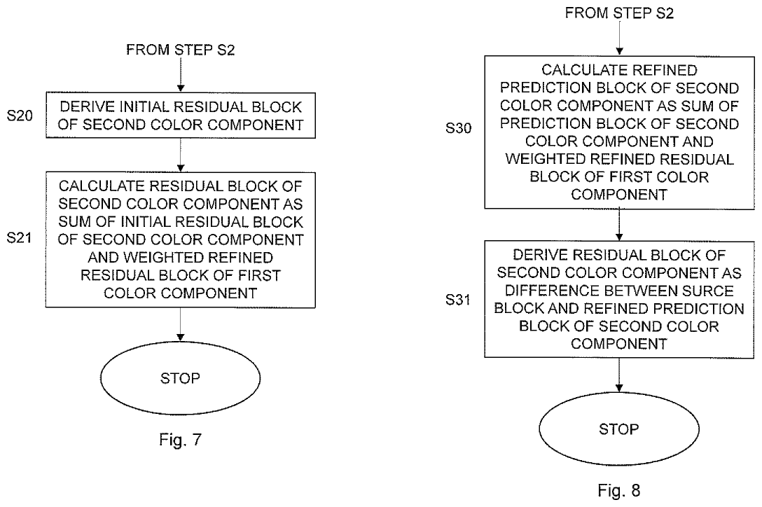

FIG. 7 is a flow chart of an embodiment of step S3. The method continues from step S2 in FIG. 6. A next step S20 derives an initial residual block of the second color component (res₂). The residual block of the second color component (res′₂) is then calculated in step S21 as a sum of i) the initial residual block of the second color component (res₂) and ii) the refined residual block of the first color component (res′₁) multiplied by a weighting factor (α).

Thus, in this embodiment, an initial residual block of the second color component is refined or modified by a weighted version of the refined residual block of the first color component as derived in step S2 in FIG. 6, i.e., res′₂=res₂+α×res′₁. This equation can be further expanded into res′₂=res₂+α×res′₁=res₂+α×rec′₁−α×pred₁=res₂+α×f(pred₁+res₁)−α×pred₁=res₂+α×f(rec₁)−α×pred₁.

In an embodiment, step S20 comprises deriving the initial residual block of the second color component as a difference between a source block of the second color component in the picture and a prediction block of the second color component.

This embodiment of step S20 is preferably performed at the encoding side, such as in an encoder, having access to the original pictures of a video sequence and the source block of the second color component. This embodiment thereby derives the initial residual block of the second color component as the difference between the source block of the second color component (source₂) and the prediction block of the second color component (pred₂), i.e., res₂=source₂−pred₂.

Accordingly, the residual block of the second color component can then be calculated as res′₂=source₂−pred₂+α×res′₁. The refinement of the residual block of the second color component could therefore be seen as a refinement of the prediction block of the second color component pred′₂, and where this refined prediction block of the second color component is derived as difference between the prediction block of the second color component and the weighted version of the refined residual of the first color component, i.e., as res′₂=source₂−(pred₂−α×res′₁)=source₂−pred′₂, with pred′₂=pred₂−α×res′₁. The refined prediction block of the second color component may also be expressed as pred′₂=pred₂−α×rec′₁+α×pred₁=pred₂−α×f(pred₁+res₁)+α×pred₁=pred₂−α×f(rec₁)+α×pred₁.

Hence, in an embodiment the residual block of the second color component is predicted from the source block of the second color component and a refined prediction block of the second color component, preferably as a difference between the source block of the second color component and the refined prediction block of the second color component. This refined prediction block of the second color component is in turn derived from the prediction block of the second color component and the refined residual block of the first color component multiplied by the weighting factor, preferably as a difference between the prediction block of the second color component and the refined residual block of the first color component multiplied by the weighting factor.

In another embodiment, step S20 comprises decoding a bit stream representing a coded version of the picture to obtain the initial residual block.

This embodiment of step S20 is preferably performed at the decoding side, such as in a decoder that receives a bit stream as an encoded representation of pictures in a video sequence. In such a case, the decoder decodes the bit stream to get the quantized and optionally transformed values of the initial residual block of the second color component. These value are then preferably inverse quantized and optionally inverse transformed to obtain the initial residual block of the second color component.

In either case, the refined residual block of the first color component multiplied by a weighting factor is added to the initial residual block of the second color component, i.e., res′₂=res₂+α×res′₁. The weighting factor could be fixed and standardized, the same for a picture in a video sequence, the same for a slice in a picture in a video sequence or be determined for each residual block of the second color component. The value of the weighting factor may also depend on which color component is the second color component and/or which color component is the first luma component.

The embodiment described above in connection with FIG. 7 is in particular applicable to cross-component prediction (CCP) in which the residual block of a chroma component is predicted from the residual block of a luma component. However, in clear contrast to prior art CCP, this variant of CCP uses a refined residual block of the luma component derived as a difference between the refined, i.e., clipped and/or filtered, reconstruction block of the luma component and the prediction block of the luma component.

In an embodiment, the residual block of a chroma component is calculated as:

r[x][y]+=(ResScaleVal[cIdx][xTbY][yTbY]*((r_{Y}′[x][y]<<BitDepth_{C})>>BitDepth_{Y}))>>3

wherein x=0 . . . nTbS−1, y=0 . . . nTbS−1, r[x][y] is an (nTbS)×(nTbS) array of chroma residual samples, r_{Y}′[x][y] is an (nTbS)×(nTbS) array of refined luma residual samples, cIdx is an index identifying the color component, (xTbY, yTbY) specifies the top-left sample of the current luma transform block relative to the top-left luma sample of the current picture, nTbS is a variable specifying the transform block size and ResScaleVal[cIdx][xTbY][yTbY] specifies the scaling factor used in cross-component residual prediction. This scaling factor is preferably determined as disclosed in equation 7-82 in [5], i.e., ResScaleVal[cIdx][x0][y0]=(1<<(log 2_res_scal_abs_plus[cIdx−1]−1))*(1−2*res_scale_Sign_flag[cIdx−1]), and the parameters log 2_res_scal_abs_plus[c] and res_scale_Sign_flag[c] are signaled in the bit stream.

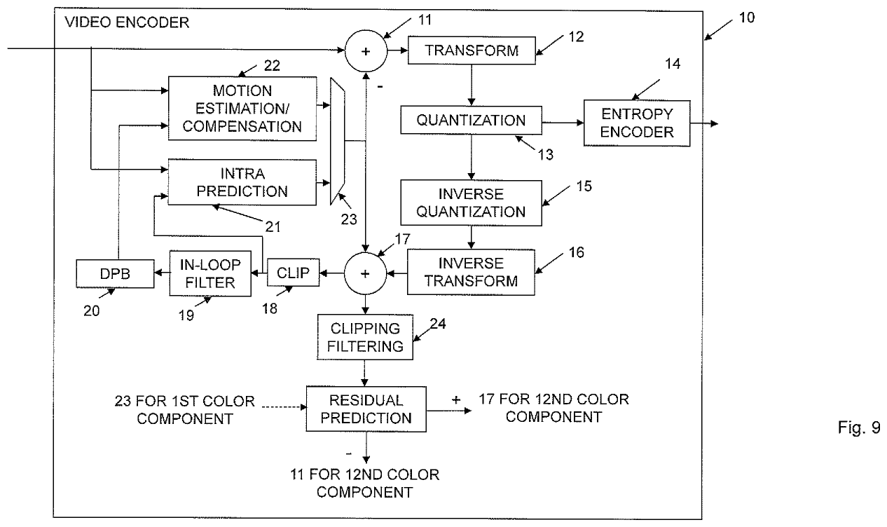

FIG. 8 is a flow chart of another embodiment of step S3. The method continues from step S2 in FIG. 6. A next step S30 calculates a refined prediction block of the second color component (pred′₂) as a sum of i) a prediction block of the second color component (pred₂) and ii) the refined residual of the first color component (res′₁) multiplied by a weighting factor (α). A next step S31 then derives the residual block of the second color component (res′₂) as a difference between a source block of the second color component (source₂) and the refined prediction block of the second color component (pred′₂).

Thus, step S30 comprises calculating pred′₂=pred₂+α×res′₁. The following step S31 calculates res′₂=source₂−pred′₂=source₂−(pred₂+α×res′₁)=source₂−pred₂−α×res′₁. Note that the initial residual of the second color component res₂=source₂−pred₂. Accordingly, res′₂=res₂−α×res′₁.

The embodiment described above in connection with FIG. 8 is in particular applicable to cross-component linear model (CCLM) prediction in which the prediction block of one chroma component is predicted from the residual block of the other chroma component. However, in clear contrast to prior art CCLM, this variant of CCLM uses a refined residual block of the other chroma component derived as a difference between the refined, i.e., clipped and/or filtered, reconstruction block of the other chroma component and the prediction block of the other chroma component.

Hence, in this embodiment a weighted refined reconstructed Cb residual block is added to the initial or original Cr prediction block to form the refined or final Cr prediction block. This refined Cr prediction block can then be used to calculate the refined Cr residual block as described above.

In this embodiment, the Cr chroma component is predicted from the Cb chroma component. In other embodiment, the Cb chroma component is instead predicted from the Cr chroma component.

The weighting factor α is preferably calculated as defined in equation (11) in [2], i.e.,

$$α = \frac{N \sum {x}_{i} {y}_{i} - \sum {x}_{i} \sum {y}_{i} + λ \times ( - 0.5 )}{N \sum {x}_{i} {x}_{i} - \sum {x}_{i} \sum {x}_{i} + λ}$$

Note that the weighting factor used in the embodiments discussed above in connection with FIG. 7 and CCP is typically different from the weighting factor used in the embodiments discussed above in connection with FIG. 8 and CCLM.

### Embodiment 1

In cases where a residual for a first color component will be used for prediction of the residual for a second color component, a reconstruction with clipping is first made for the first color component and then a refined residual for the first color component is derived as the difference between the clipped reconstruction and the prediction of the first color component (intra and/or inter). Then, the refined residual for the first color component is used for prediction of the second color component. Below is a pseudo-code to illustrate this in two steps for samples of a block. First derive the reconstruction with clipping and then determine the refined residual and finally using the refined residual for prediction of a second color component.

// 1. Derive reconstruction with clipping for a block of width=uiWidth and height=uiHeight
// Reco = Pred + Resi, where Pred is a prediction block and Resi is a residual block and Reco is a clipped
// reconstruction where ClipBD clips the sum of prediction (piPred) and residual (piResi) to stay within the
// allowed range of samples.
// Store pointers to top left position of prediction block, residual block and reconstruction block.
Pel *piPredTemp = piPred;
Pel *piResiTemp = piResi;
Pel *piRecoTemp = piReco;
for (UInt uiY = 0; uiY < uiHeight; ++uiY)
{

for (UInt uiX = 0; uiX < uiWidth; ++uiX)
{

piReco[uiX] = ClipBD(piPred[uiX] + piResi[uiX], clipbd);

}
// Update of the pointers to next row of samples of the prediction block, residual block and reconstruction
// block.
piPred += uiPredStride;
piResi += uiStrideRes;
piReco += uiRecStride;

}
// 2. Determine a refined residual based on clipped reconstruction
// Resi′ = Reco′ − Pred, where Reco’ is a clipped reconstruction block and Pred is a prediction block, Resi’ is
// a refined residual block.
// Set the pointers to the top left position of the prediction block, residual block and reconstruction block.
piPred = piPredTemp;
piResi = piResiTemp;
piReco = piRecoTemp;
for (UInt uiY = 0; uiY < uiHeight; ++uiY)
{

for (UInt uiX = 0; uiX < uiWidth; ++uiX)
{

piResi[uiX] = piReco[uiX] − piPred[uiX];

}
// Update of the pointers to next row of samples of the prediction block, residual block and reconstruction
// block.
piPred += uiPredStride;
piResi += uiStrideRes;
piReco += uiRecStride;

}
// 3. Residual prediction
piResi2=residualPrediction(piResi)

### Embodiment 2

In cases where residual of a first color component will be used for prediction of a residual of a second color component, a reconstruction of the first color component with clipping is first made, then a filtering is applied on the clipped reconstruction and then a refined residual of the first color component is derived as the difference between the filtered reconstruction and the prediction of the first color component (intra and/or inter). Then the refined residual for the first color component is used for prediction of the second color component. Below is a pseudo-code to illustrate this in four steps for samples of a block. Derive the reconstruction with clipping, filter the reconstruction, determine the refined residual and finally, using the refined residual, predict a second color component.

// 1. Derive reconstruction with clipping for a block of width=uiWidth and height=uiHeight
// Reco = Pred + Resi, where Pred is a prediction block and Resi is a residual block and Reco is a clipped
// reconstruction where ClipBD clips the sum of prediction (piPred) and residual (piResi) to stay within the
// allowed range of samples.
// Store pointers to top left position of prediction block, residual block and reconstruction block.
Pel *piPredTemp = piPred;
Pel *piResiTemp = piResi;
Pel *piRecoTemp = piReco;
for (UInt uiY = 0; uiY < uiHeight; ++uiY)
{

for (UInt uiX = 0; uiX < uiWidth; ++uiX)
{

piReco[uiX] = ClipBD(piPred[uiX] + piResi[uiX], clipbd);

}
// Update of the pointers to next row of samples of the prediction block, residual block and reconstruction
// block.
piPred += uiPredStride;
piResi += uiStrideRes;
piReco += uiRecStride;

}
// 2. Reco′ = filter(Reco), filter the reconstruction.
for (UInt j = 0; j < uiHeight / uiMinSize; j++)
{

for(UInt i = 0; i < uiWidth / uiMinSize; i++)
{

// Copy reconstruction to temporary buffer for filtering.
for (UInt k = 0; k < uiMinSize; k++)
{

memcpy(tempblock + k * uiMinSize, piReco + (j * uiMinSize + k) * uiRecStride + i * uiMinSize,

uiMinSize * sizeof(Short));

k++;
memcpy(tempblock + k * uiMinSize, piReco + (j * uiMinSize + k) * uiRecStride + i * uiMinSize,

uiMinSize * sizeof(Short));

}
Filter(pcCU, tempblock);
// Copy filtered reconstruction back to the reconstruction buffer
for (UInt k = 0; k < uiMinSize; k++)
{

memcpy(piReco + (j * uiMinSize + k) * uiRecStride + i * uiMinSize, tempblock + k * uiMinSize,

uiMinSize * sizeof(Short));

k++;
memcpy(piReco + (j * uiMinSize + k) * uiRecStride + i * uiMinSize, tempblock + k * uiMinSize,

uiMinSize * sizeof(Short));

}

}

}
// 3. Determine residual based on filtered reconstruction
// Resi′ = Reco′ − Pred, where Reco’ is a clipped reconstruction block and Pred is a prediction block, Resi’ is
// a refined residual block.
// Set the pointers to the top left position of the prediction block, residual block and reconstruction block.
piPred = piPredTemp;
piResi = piResiTemp;
piReco = piRecoTemp;
for (UInt uiY = 0; uiY < uiHeight; ++uiY)
{

for (UInt uiX = 0; uiX < uiWidth; ++uiX)
{

piResi[uiX] = piReco[uiX] − piPred[uiX];

}
// Update of the pointers to next row of samples of the prediction block, residual block and reconstruction
// block.
piPred += uiPredStride;
piResi += uiStrideRes;
piReco += uiRecStride;

}
// 4. Residual prediction
piResi2=residualPrediction(piResi)

### Embodiment 3

In cases where residual of a first color component will be used for prediction of a residual of a second color component, a reconstruction of the first color component with clipping is first made, then a filtering is applied on the clipped reconstruction and then a refined residual of the first color component is derived as the difference between the filtered reconstruction and the prediction of the first color component (intra and/or inter). Then the refined residual for the first color component is used for prediction of the second color component. Below is a pseudo-code to illustrate this in four steps for samples of a block. Derive the reconstruction with clipping, filter the reconstruction, determine the refined residual and finally, using the refined residual, predict a second color component.

// 1. Derive reconstruction with clipping for a block of width=uiWidth and height=uiHeight
// Reco = Pred + Resi, where Pred is a prediction block and Resi is a residual block and Reco is a clipped
// reconstruction where ClipBD clips the sum of prediction (piPred) and residual (piResi) to stay within the
// allowed range of samples.
// Store pointers to top left position of prediction block, residual block and reconstruction block.
Pel *piPredTemp = piPred;
Pel *piResiTemp = piResi;
Pel *piRecoTemp = piReco;
for (UInt uiY = 0; uiY < uiHeight; ++uiY)
{

for (UInt uiX = 0; uiX < uiWidth; ++uiX)
{

piReco[uiX] = ClipBD(piPred[uiX] + piResi[uiX], clipbd);

}
// Update of the pointers to next row of samples of the prediction block, residual block and reconstruction
// block.
piPred += uiPredStride;
piResi += uiStrideRes;
piReco += uiRecStride;

}
// 2. Reco′ = filter(Reco), filter the reconstruction.
// Copy reconstruction to temporary buffer for filtering.
for (UInt j = 0; j < uiHeight; j++)
{

memcpy(tempblock +j * uiWidth, piReco +j * uiRecStride, uiWidth * sizeof(Short));

}
Filter(pcCU, tempblock);
// Copy filtered reconstruction back to the reconstruction buffer
for (UInt j = 0; j < uiHeight; j++)
{

memcpy(piReco +j * uiRecStride, tempblock +j * uiWidth, uiWidth * sizeof(Short));

}
delete□ tempblock;
// 3. Determine residual based on filtered reconstruction
// Resi′ = Reco′ − Pred, where Reco’ is a clipped reconstruction block and Pred is a prediction block, Resi’ is
// a refined residual block.
// Set the pointers to the top left position of the prediction block, residual block and reconstruction block.
piPred = piPredTemp;
piResi = piResiTemp;
piReco = piRecoTemp;
for (UInt uiY = 0; uiY < uiHeight; ++uiY)
{

for (UInt uiX = 0; uiX < uiWidth; ++uiX)
{

piResi[uiX] = piReco[uiX] − piPred[uiX];

}
// Update of the pointers to next row of samples of the prediction block, residual block and reconstruction
// block.
piPred += uiPredStride;
piResi += uiStrideRes;
piReco += uiRecStride;

}
// 4. Residual prediction
piResi2=residualPrediction(piResi)

### Embodiment 4

In this embodiment, the residual in embodiment 1, 2 or 3 is derived for one color component that will be used for cross-component prediction (CCP) or cross-component linear model (CCLM) prediction. For example, luma residual is refined before used for predicting chroma residual in CCP or one chroma residual is refined before used for predicting another chroma residual in CCLM.

### Embodiment 5

In this embodiment, the reconstruction in embodiment 2, 3 or 4 is filtered with a bilateral filter.

### Embodiment 6

In this embodiment, the use (on) or not use (off) of refinement of a residual component is controlled implicitly by presence of another coding parameter or explicitly controlled by signaling an on/off flag. The on/off can be controlled on sequence level, such as in a sequence parameter set (SPS) or a SPS extension; picture level, such as in a picture parameter set (PPS) or a PPS extension; slice level, such as in a slice header; or block level, such as in a block header.

An aspect of the embodiments defines a method, performed by an encoder or a decoder, for predicting residuals of color components in a picture. The picture comprises at least a first color component and a second color component. The first color component is further associated with a reconstructed first color component. The method comprises refining, by filtering or clipping, the reconstructed first color component and predicting a residual of the second color component from the refined reconstructed first color component.

Another aspect of the embodiments relates to a device for residual prediction for a picture. The device is configured to determine a refined reconstruction block of a first color component in the picture by at least one of clipping and bilateral filtering a sum of a prediction block of the first color component and a residual block of the first color component. The device is also configured to predict a residual block of a second color component from the refined reconstruction block of the first color component.

In an embodiment, the device is configured to determine the refined reconstruction block of the first color component by clipping the sum of the prediction block of the first color component and the residual block of the first color component to stay within an allowed range for the first color component

In another embodiment, the device is configured to clip the sum of the prediction block of the first color component and the residual block of the first color component to stay within an allowed range for the first color component to form a clipped reconstruction block of first color component. The device is also configured to filter the clipped reconstruction block of the first color component with a filter, preferably a bilateral filter, to form the refined reconstruction block of the first color component.

In a further embodiment, the device is configured to filter the sum of the prediction block of the first color component and the residual block of the first color component with a filter, preferably a bilateral filter, to form a filtered reconstruction block of first color component. The device is configured to clip the filtered reconstruction block to stay within an allowed range for the first color component to form the refined reconstruction block of the first color component.

In yet another embodiment, the device is configured to filter the sum of the prediction block of the first color component and the residual block of the first color component with a bilateral filter to form the refined reconstruction block of the first color component.

In an embodiment, the device is configured to derive a refined residual block of the first color component as a difference between the refined reconstruction block of the first color component and the prediction block of the first color component. The device is also configured to predict the residual block of the second color component from the refined residual block of the first color component.

In a particular embodiment, the device is configured to derive an initial residual block of the second color component. The device is also configured to calculate the residual block of the second color component as a sum of i) the initial residual block of the second color component and ii) the refined residual block of the first color component multiplied by a weighting factor.

It will be appreciated that the methods, method steps and devices, device functions described herein can be implemented, combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Alternatively, or as a complement, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device or unit in which the proposed technology is implemented. It may also be possible to re-use existing software, e.g., by reprogramming of the existing software or by adding new software components.

FIG. 11 is a schematic block diagram illustrating an example of a device 100 for residual prediction based on a processor-memory implementation according to an embodiment. In this particular example, the device 100 comprises a processor 101, such as processing circuitry, and a memory 102. The memory 102 comprises instructions executable by the processor 101.

In an embodiment, the processor 101 is operative to determine the refined reconstruction block of the first color component by at least one of clipping and bilateral filtering the sum of the prediction block of the first color component and the residual block of the first color component. The processor 101 is also operative to predict the residual block of the second color component from the refined reconstruction block of the first color component.

Optionally, the device 100 may also include a communication circuit, represented by an input and output (I/O) unit 103 in FIG. 11. The I/O unit 103 may include functions for wired and/or wireless communication with other devices and/or network nodes in a wired or wireless communication network. In a particular example, the I/O unit 103 may be based on radio circuitry for communication with one or more other network devices or user equipment, including transmitting and/or receiving information. The I/O unit 103 may be interconnected to the processor 101 and/or memory 102. By way of example, the I/O unit 103 may include any of the following: a receiver, a transmitter, a transceiver, I/O circuitry, input port(s) and/or output port(s).

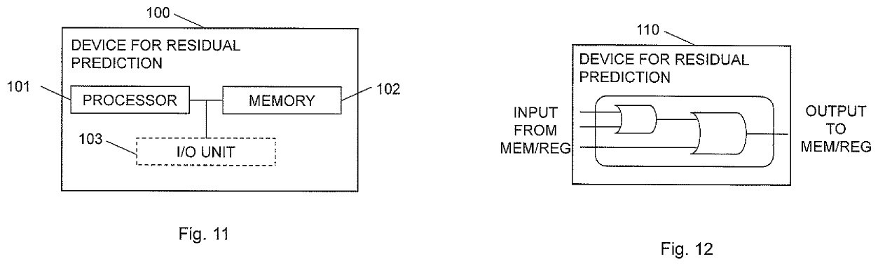

FIG. 12 is a schematic block diagram illustrating another example of a device 110 for residual prediction based on a hardware circuitry implementation according to an embodiment. Particular examples of suitable hardware circuitry include one or more suitably configured or possibly reconfigurable electronic circuitry, e.g., Application Specific Integrated Circuits (ASICs), FPGAs, or any other hardware logic such as circuits based on discrete logic gates and/or flip-flops interconnected to perform specialized functions in connection with suitable registers (REG), and/or memory units (MEM).

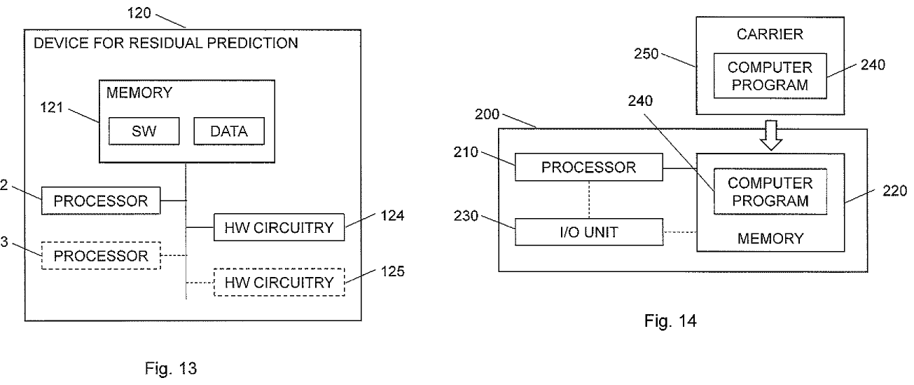

FIG. 13 is a schematic block diagram illustrating yet another example of a device 120 for residual prediction based on combination of both processor(s) 122, 123 and hardware circuitry 124, 125 in connection with suitable memory unit(s) 121. The device 120 comprises one or more processors 122, 123, memory 121 including storage for software (SW) and data, and one or more units of hardware circuitry 124, 125. The overall functionality is thus partitioned between programmed software for execution on one or more processors 122, 123, and one or more pre-configured or possibly reconfigurable hardware circuits 124, 125. The actual hardware-software partitioning can be decided by a system designer based on a number of factors including processing speed, cost of implementation and other requirements.

FIG. 14 is a schematic diagram illustrating an example of a device 200 for residual prediction according to an embodiment. In this particular example, at least some of the steps, functions, procedures, modules and/or blocks described herein are implemented in a computer program 240, which is loaded into the memory 220 for execution by processing circuitry including one or more processors 210. The processor(s) 210 and memory 220 are interconnected to each other to enable normal software execution. An optional I/O unit 230 may also be interconnected to the processor(s) 210 and/or the memory 220 to enable input and/or output of relevant data, such as reconstructed or decoded pictures of a video sequence.

The term ‘processor’ should be interpreted in a general sense as any circuitry, system or device capable of executing program code or computer program instructions to perform a particular processing, determining or computing task.

The processing circuitry including one or more processors 210 is thus configured to perform, when executing the computer program 240, well-defined processing tasks such as those described herein.

The processing circuitry does not have to be dedicated to only execute the above-described steps, functions, procedure and/or blocks, but may also execute other tasks.

In a particular embodiment, the computer program 240 comprises instructions, which when executed by at least one processor 210, cause the at least one processor 210 to determine a refined reconstruction block of a first color component in a picture by at least one of clipping and bilateral filtering a sum of a prediction block of the first color component and a residual block of the first color component. The at least one processor 210 is also caused to predict a residual block of a second color component from the refined reconstruction block of the first color component.

The proposed technology also provides a carrier 250 comprising the computer program 240. The carrier 250 is one of an electronic signal, an optical signal, an electromagnetic signal, a magnetic signal, an electric signal, a radio signal, a microwave signal, or a computer-readable storage medium.

By way of example, the software or computer program 240 may be realized as a computer program product, which is normally carried or stored on a computer-readable medium 250, in particular a non-volatile medium. The computer-readable medium may include one or more removable or non-removable memory devices including, but not limited to a Read-Only Memory (ROM), a Random Access Memory (RAM), a Compact Disc (CD), a Digital Versatile Disc (DVD), a Blu-ray disc, a Universal Serial Bus (USB) memory, a Hard Disk Drive (HDD) storage device, a flash memory, a magnetic tape, or any other conventional memory device. The computer program 240 may thus be loaded into the operating memory 220 of a device 200 for execution by the processing circuitry 210 thereof.

A further aspect of the embodiments defines a computer program for an encoder comprising a computer program code which, when executed, causes the encoder to refine, by filtering or clipping, the reconstructed first color component and predict a residual of the second color component from the refined reconstructed first color component.

A further aspect of the embodiments defines a computer program for a decoder comprising a computer program code which, when executed, causes the decoder to refine, by filtering or clipping, the reconstructed first color component and predict a residual of the second color component from the refined reconstructed first color component.

A further aspect of the embodiments defines a computer program product comprising a computer program for an encoder and a computer readable means on which the computer program for an encoder is stored.

A further aspect of the embodiments defines a computer program product comprising a computer program for a decoder and a computer readable means on which the computer program for a decoder is stored.

The flow diagram or diagrams presented herein may be regarded as a computer flow diagram or diagrams, when performed by one or more processors. A corresponding device for residual prediction for a picture may be defined as a group of function modules, where each step performed by the processor corresponds to a function module. In this case, the function modules are implemented as a computer program running on the processor.

The computer program residing in memory may, thus, be organized as appropriate function modules configured to perform, when executed by the processor, at least part of the steps and/or tasks described herein.

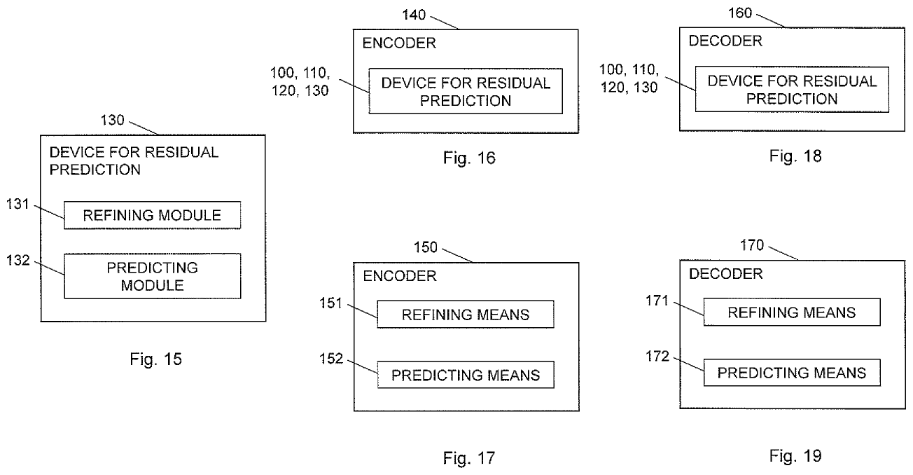

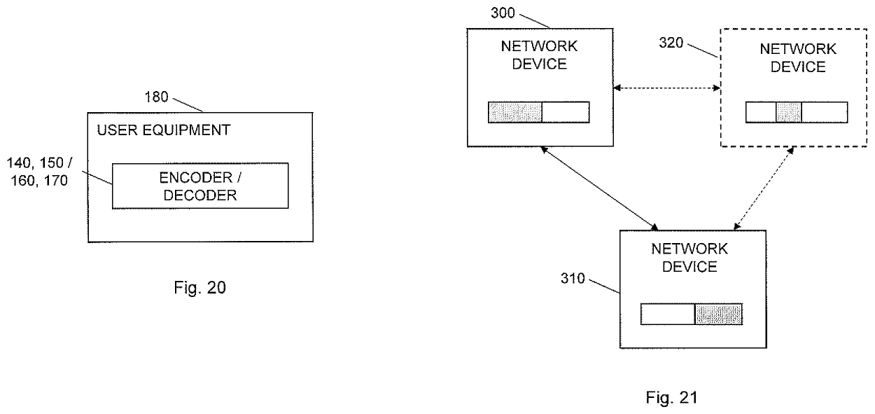

FIG. 15 is a schematic block diagram of a device 130 for residual prediction for a picture. The device 130 comprises a refining module 131 for determining a refined reconstruction block of a first color component in the picture by at least one of clipping and bilateral filtering a sum of a prediction block of the first color component and a residual block of the first color component. The device 130 also comprises a predicting module 132 for predicting a residual block of a second color component from the refined reconstruction block of the first color component.

An embodiment relates to an encoder 140, such as a video encoder, comprising a device for residual prediction 100, 110, 120, 130 according to the embodiments, such as illustrated in any of FIGS. 11-13, 15, see FIG. 16.

In an embodiment, the encoder 140 is configured to derive an initial residual block of the second color component as a difference between a source block of the second color component in the picture and a prediction block of the second color component.

FIG. 17 illustrates another embodiment of an encoder 150. The encoder 150 comprises a refining means 151 configured to refine, by filtering or clipping, a reconstructed first color component and a predicting means 152 configured to predict a residual of the second color component from the refined reconstructed first color component.

Another aspect of the embodiments defines an encoder, for predicting residuals of color components in a picture. The picture comprises at least a first color component and a second color component. The first color component is further associated with a reconstructed first color component. The encoder is configured to refine, by filtering or clipping, the reconstructed first color component and to predict a residual of the second color component from the refined reconstructed first color component.

Another aspect of the embodiments defines an encoder for predicting residuals of color components in a picture. The picture comprises at least a first color component and a second color component. The first color component is further associated with a reconstructed first color component. The encoder comprises a refining module for filtering or clipping the reconstructed first color component and a predicting module for predicting a residual of the second color component from the refined reconstructed first color component.

FIG. 9 is a schematic block diagram of a video encoder 10 according to an embodiment.

A current source or sample block is predicted by performing a motion estimation by a motion estimator 22 from already encoded and reconstructed sample block(s) in the same picture and/or in reference picture(s). The result of the motion estimation is a motion vector in the case of inter prediction. The motion vector is utilized by a motion compensator 22 for outputting an inter prediction of the sample block (prediction block).

An intra predictor 21 computes an intra prediction of the current sample block. The outputs from the motion estimator/compensator 22 and the intra predictor 21 are input in a selector 23 that either selects intra prediction or inter prediction for the current sample block. The output from the selector 21 is input to an error calculator in the form of an adder 11 that also receives the source sample values of the current sample block. The adder 11 calculates and outputs a residual error (residual block) as the difference in sample values between the sample or source block and its prediction, i.e., prediction block.

The error is transformed in a transformer 12, such as by a discrete cosine transform (DCT), and quantized by a quantizer 13 followed by coding in an encoder 14, such as by an entropy encoder. In inter coding, also the estimated motion vector is brought to the encoder 14 for generating the coded representation of the current sample block.

The transformed and quantized residual error for the current sample block is also provided to an inverse quantizer 15 and inverse transformer 16 to reconstruct the residual error (residual block). This residual error is added by an adder 17 to the prediction (prediction block) output from the motion compensator 22 or the intra predictor 21 to create a reconstructed sample block (reconstruction block) that can be used as prediction block in the prediction and coding of other sample blocks. This reconstructed sample block is first clipped 18 and subject to in-loop filtering 19 before it is stored in a Decoded Picture Buffer (DPB) 20, where it is available to the motion estimator/compensator 22. The output from the clipping operation 18 is preferably also input to the intra predictor 21 to be used as a non-clipped and unfiltered prediction block.

FIG. 9 schematically illustrates that the reconstruction block derived for the first color component, such as luma Y′ component or a Cb chroma component, is subject to a clipping and/or filtering 24 according to the embodiments and to be used as input when predicting the residual block of the second color component, such as a Cr chroma component.

The output of clipping and/or filtering 24 is input to the residual prediction for the second color component. Optionally, also the prediction of the first color component from the selector 23 may be input in the residual prediction. The output of the residual prediction of the second color component is input to the adder 11 to remove the residual prediction from the source block and as input to the adder 17 to add back the residual prediction of the second color component before reconstruction of the second color component.

An embodiment relates to a decoder 160, such as a video decoder, comprising a device for residual prediction 100, 110, 120, 130 according to the embodiments, such as illustrated in any of FIGS. 11-13, 15, see FIG. 18.

In an embodiment, the decoder 160 is configured to decode a bit stream representing a coded version of the picture to obtain the initial residual block of the second color component.

FIG. 19 illustrates another embodiment of a decoder 170. The decoder 170 comprises a refining means 171 configured to refine, by filtering or clipping, a reconstructed first color component and a predicting means 172 configured to predict a residual of the second color component from the refined reconstructed first color component.

Another aspect of the embodiments defines a decoder for predicting residuals of color components in a picture. The picture comprises at least a first color component and a second color component. The first color component is further associated with a reconstructed first color component. The decoder is configured to refine, by filtering or clipping, the reconstructed first color component and to predict a residual of the second color component from the refined reconstructed first color component.

Another aspect of the embodiments defines a decoder for predicting residuals of color components in a picture. The picture comprises at least a first color component and a second color component. The first color component is further associated with a reconstructed first color component. The decoder comprises a refining module for filtering or clipping the reconstructed first color component and a predicting module for predicting a residual of the second color component from the refined reconstructed first color component.

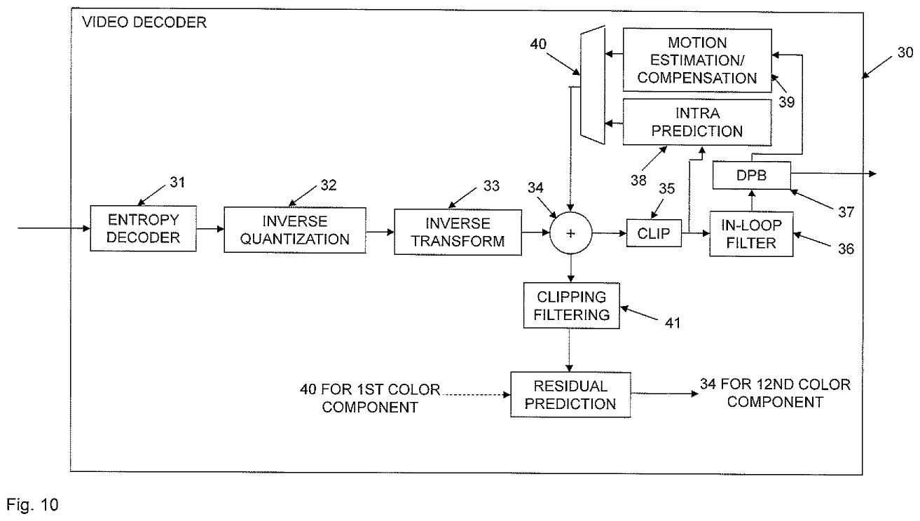

FIG. 10 is a schematic block diagram of a video decoder 30 according to an embodiment. The video decoder 30 comprises a decoder 31, such as entropy decoder, for decoding a bit stream comprising an encoded representation of a sample block to get a quantized and transformed residual error. The residual error is dequantized in an inverse quantizer 32 and inverse transformed by an inverse transformer 33 to get a decoded residual error (residual block).

The decoded residual error is added in an adder 34 to the sample prediction values of a prediction block. The prediction block is determined by a motion estimator/compensator 39 or intra predictor 38, depending on whether inter or intra prediction is performed. A selector 40 is thereby interconnected to the adder 34 and the motion estimator/compensator 39 and the intra predictor 38. The resulting decoded sample block output from the adder 34 is a reconstruction of the original sample block (reconstruction block) and is subject to a clipping 35 and in-loop filtering 36 before it is temporarily stored in a DPB 37. The reconstruction block can then be used as prediction block for subsequently decoded sample blocks. The DPB 37 is thereby connected to the motion estimator/compensator 39 to make the stored sample blocks available to the motion estimator/compensator 39. The output from the clipping 35 is preferably also input to the intra predictor 38 to be used as a non-clipped and unfiltered prediction block. The reconstructed sample block is furthermore output from the video decoder 30, such as output for display on a screen.

FIG. 10 schematically illustrates that the reconstruction block derived for the first color component, such as luma Y′ component or a Cb chroma component, is subject to a clipping and/or filtering 41 according to the embodiments and to be used as input when predicting the residual block of the second color component, such as a Cr chroma component.

The output of clipping and/or filtering 41 is input to the residual prediction for the second color component. Optionally, also the prediction of the first color component from the selector 40 may be input in the residual prediction. The output of the residual prediction of the second color component is input to the adder 34 to add back the residual prediction of the second color component before reconstruction of the second color component.

A further embodiment relates to a user equipment 180 comprising an encoder 140, 150 and/or a decoder 160, 170 according to the embodiments. In a particular embodiment, the user equipment is selected from the group consisting of a mobile telephone, such as a smart phone; a tablet; a desktop; a netbook; a multimedia player; a video streaming server; a set-top box; a game console and a computer.

The device for residual prediction, the encoder and/or decoder of the embodiments may alternatively be implemented in a network device or equipment being or belonging to a network node in a communication network. Such a network device may be an equipment for converting video according to one video coding standard to another video coding standard, i.e., transcoding. The network device can be in the form of or comprised in a radio base station, a Node-B or any other network node in a communication network, such as a radio-based network.

It is becoming increasingly popular to provide computing services, hardware and/or software, in network equipment, such as network devices, nodes and/or servers, where the resources are delivered as a service to remote locations over a network. By way of example, this means that functionality, as described herein, can be distributed or re-located to one or more separate physical devices, nodes or servers. The functionality may be re-located or distributed to one or more jointly acting physical and/or virtual machines that can be positioned in separate physical node(s), i.e., in the so-called cloud. This is sometimes also referred to as cloud computing, which is a model for enabling ubiquitous on-demand network access to a pool of configurable computing resources such as networks, servers, storage, applications and general or customized services.

FIG. 21 is a schematic diagram illustrating an example of how functionality can be distributed or partitioned between different network devices in a general case. In this example, there are at least two individual, but interconnected network devices 300, 310, which may have different functionalities, or parts of the same functionality, partitioned between the network devices 300, 310. There may be additional network devices 320 being part of such a distributed implementation. The network devices 300, 310, 320 may be part of the same wireless or wired communication system, or one or more of the network devices may be so-called cloud-based network devices located outside of the wireless or wired communication system.

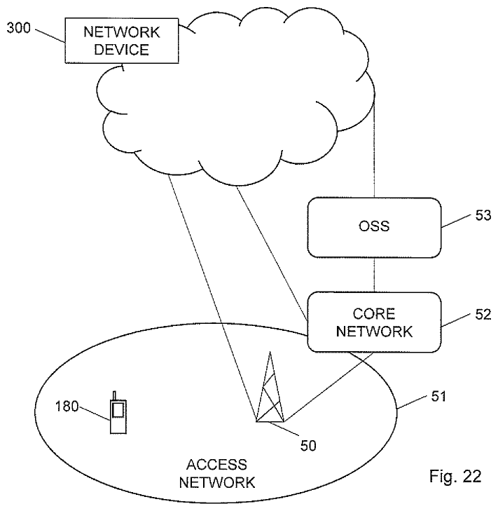

FIG. 22 is a schematic diagram illustrating an example of a wireless communication network or system, including an access network 51 and a core network 52 and optionally an operations and support system (OSS) 53 in cooperation with one or more cloud-based network devices 300. The figure also illustrates a user equipment 180 connected to the access network 51 and capable of conducting wireless communication with a base station representing an embodiment of a network node 50.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### REFERENCES

[1] ITU-T, Telecommunication Standardization Sector of ITU, H.265 (04/2015), Series H: Audiovisual and multimedia systems, Infrastructure of audiovisual services Coding of moving video, High efficiency video coding, section 8.6.6 Residual modification process for transform blocks using cross-component prediction.
[2] Chen et al., Coding tools investigation for next generation video coding based on HEVC, Proc. of SPIE Vol. 9599 95991B-1, section Cross Component Prediction.
[3] Galpin et al. Adaptive Clipping in JEM2.0, Joint Video Expoloration Team (JVET) of ITU-T SG 16 WP 3 and ISO/IEC JTC 1/SC 29/WG 11, 3^{rd} Meeting: Geneva, CH, 26 May 1 Jun. 2016, Document: JVET-00040-3
[4] Bordes et al. EE7 Adaptive Clipping syntax, Joint Video Expoloration Team (JVET) of ITU-T SG 16 WP 3 and ISO/IEC JTC 1/SC 29/WG 11, 4th Meeting: Chengdu, C N, 15-21 Oct. 2016, Document: JVET-D0033-syntax
[5] ITU-T, Telecommunication Standardization Sector of ITU, H.265 (04/2015), Series H: Audiovisual and multimedia systems, Infrastructure of audiovisual services Coding of moving video, High efficiency video coding, section 7.4.9.12 Cross-component prediction semantics.

1. A method for residual prediction for a picture, the method comprises:
determining a refined reconstruction block of a first color component in the picture by at least one of clipping and bilateral filtering a sum of a prediction block of the first color component and a residual block of the first color component; and
predicting a residual block of a second color component from the refined reconstruction block of the first color component.

2. The method of claim 1, wherein determining the refined reconstruction block comprises determining the refined reconstruction block by clipping the sum of the prediction block of the first color component and the residual block of the first color component to stay within an allowed range for the first color component.

3. The method of claim 1, wherein determining the refined reconstruction block comprises:
clipping the sum of the prediction block of the first color component and the residual block of the first color component to stay within an allowed range for the first color component to form a clipped reconstruction block of first color component; and
filtering the clipped reconstruction block of the first color component with a filter to form the refined reconstruction block of the first color component.

4. The method of claim 1, wherein determining the refined reconstruction block comprises:
filtering the sum of the prediction block of the first color component and the residual block of the first color component with a filter to form a filtered reconstruction block of first color component; and
clipping the filtered reconstruction block to stay within an allowed range for the first color component to form the refined reconstruction block of the first color component.

5. The method of claim 1, wherein determining the refined reconstruction block comprises determining the refined reconstruction block by filtering the sum of the prediction block of the first color component and the residual block of the first color component with a bilateral filter to form the refined reconstruction block of the first color component.

6. The method of claim 1, further comprising deriving a refined residual block of the first color component as a difference between the refined reconstruction block of the first color component and the prediction block of the first color component, wherein predicting the residual block comprises predicting the residual block of the second color component from the refined residual block of the first color component.

7. The method of claim 6, wherein predicting the residual block comprises:
deriving an initial residual block of the second color component; and
calculating the residual block of the second color component as a sum of i) the initial residual block of the second color component and ii) the refined residual block of the first color component multiplied by a weighting factor.

8. The method of claim 7, wherein
deriving the initial residual block comprises deriving the initial residual block of the second color component as a difference between a source block of the second color component in the picture and a prediction block of the second color component, or
deriving the initial residual block comprises decoding a bit stream representing a coded version of the picture to obtain the initial residual block of the second color component.

9. (canceled)

10. The method of claim 6, wherein predicting the residual block comprises:
calculating a refined prediction block of the second color component as a sum of i) a prediction block of the second color component and ii) the refined residual block of the first color component multiplied by a weighting factor; and
deriving the residual block of the second color component as a difference between a source block of the second color component in the picture and the refined prediction block of the second color component.

11. The method of claim 1, wherein
the picture comprises multiple pixels having a respective luma component and two chroma components;
second color component is one of the two chroma components; and
the first color component is the luma component or the other of the two chroma components.

12. A device for residual prediction for a picture, the device comprising:
a memory; and
a processor coupled to the memory, wherein the device is configured to:
determine a refined reconstruction block of a first color component in the picture by at least one of clipping and bilateral filtering a sum of a prediction block of the first color component and a residual block of the first color component; and
predict a residual block of a second color component from the refined reconstruction block of the first color component.

13. The device of claim 12, wherein the device is configured to determine the refined reconstruction block of the first color component by clipping the sum of the prediction block of the first color component and the residual block of the first color component to stay within an allowed range for the first color component.

14. The device of claim 12, wherein the device is configured to:
clip the sum of the prediction block of the first color component and the residual block of the first color component to stay within an allowed range for the first color component to form a clipped reconstruction block of first color component; and
a filter the clipped reconstruction block of the first color component with a filter to form the refined reconstruction block of the first color component.

15. The device of claim 12, wherein the device is configured to:
filter the sum of the prediction block of the first color component and the residual block of the first color component with a filter to form a filtered reconstruction block of first color component; and
clip the filtered reconstruction block to stay within an allowed range for the first color component to form the refined reconstruction block of the first color component.

16. The device of claim 12, wherein the device is configured to determine the refined reconstruction block of the first color component by filtering the sum of the prediction block of the first color component and the residual block of the first color component with a bilateral filter to form the refined reconstruction block of the first color component.

17. The device of claim 12, wherein the device is configured to:
derive a refined residual block of the first color component as a difference between the refined reconstruction block of the first color component and the prediction block of the first color component;
predict the residual block of the second color component from the refined residual block of the first color component;
derive an initial residual block of the second color component; and
calculate the residual block of the second color component as a sum of i) the initial residual block of the second color component and ii) the refined residual block of the first color component multiplied by a weighting factor.

18. (canceled)

19. (canceled)

20. (canceled)

21. (canceled)

22. The device of claim 12, wherein the device is an encoder, and wherein the encoder is configured to derive an initial residual block of the second color component as a difference between a source block of the second color component in the picture and a prediction block of the second color component.

23. (canceled)

24. The device of claim 12, wherein the device is a decoder, and wherein the decoder is configured to decode a bit stream representing a coded version of the picture to obtain an initial residual block of the second color component.

25. A user equipment comprising the device of claim 12.

26. A computer program product comprising a non-transitory computer readable medium storing a computer program comprising instructions, which when executed by at least one processor, caused the at least one processor to:
determine a refined reconstruction block of a first color component in a picture by at least one of clipping and bilateral filtering a sum of a prediction block of the first color component and a residual block of the first color component; and
predict a residual block of a second color component from the refined reconstruction block of the first color component.

27. (canceled)
